(19) United States
(12) Patent Application Publication
(10) Pub. No.: US 2007/0297354 A1
(43) Pub. Date: Dec. 27, 2007

(54) SIGNAL MIXER, SIGNAL TRANSMITTER AND SIGNAL RECEIVER

(75) Inventors: Masahiro Ishiyama, Kawasaki-shi (JP); Kotaro Ise, Saitama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/562,682

(22) Filed: Nov. 22, 2006

(30) Foreign Application Priority Data
Jun. 26, 2006 (JP) 2006-175468

(51) Int. Cl. H04B 7/00

(52) U.S. Cl. 370/310

(57) ABSTRACT

A signal mixer includes: a receiving unit receiving plural multicast packets each containing a DMX signal; a mixing unit mixing the DMX signals contained in the plural multicast packets received by the receiving unit; a generating unit generating a packet containing the DMX signal mixed by the mixing unit; and a transmitting unit transmitting the packet generated by the generating unit.

### CROSS-REFERENCE TO RELATED APPLICATIONS

This application is based upon and claims the benefit of priority from the prior Japanese Patent Application No. 2006-175468, filed on Jun. 26, 2006; the entire contents of which are incorporated herein by reference

### BACKGROUND

1. Field of the Invention

The present invention relates to a signal mixer, a signal transmitter and a signal receiver which handle packets including DMX signals.

2. Description of the Related Art

With increasing usage of Internet technologies, devices that have conventionally been out of the network are being connected to the network increasingly using Internet Protocol (IP). For instance, a device controlled by a signal inflowing into a shielded line and the like is also becoming to be controlled using IP. Many of these controllers are becoming to apply IP step by step. In other words, control signals are converted into IP packets and transmitted, and after that, the IP packets are converted into control signals to thereby control a device. As such a system, there exists a DMX (http://www.usitt.org/standards/DMX512.html) used for example in a dimmer controller.

In such a system, the signals transmitted by the controller are converted into IP packets and thereby transmitted in a broadcasting manner, as a general rule. For instance, when there are plural converters converting IP packets into control signals, a real-time feature can be ensured with ease.

### SUMMARY

The signal mixer according to an embodiment of the present invention includes: a receiving unit receiving plural multicast packets each containing a DMX signal; a mixing unit mixing the DMX signals contained in the plural multicast packets received by the receiving unit; a generating unit generating a packet containing the DMX signal mixed by the mixing unit; and a transmitting unit transmitting the packet generated by the generating unit.

A signal transmitter according to an embodiment of the present invention includes: a receiving unit receiving a multicast packet containing a DMX signal; a converting unit converting the multicast packet received by the receiving unit into the DMX signal; and an output unit outputting the DMX signal converted by the converting unit.

A signal receiver according to an embodiment of the present invention includes: a receiving unit receiving a multicast packet containing a DMX signal; a converting unit converting the multicast packet received by the receiving unit into the DMX signal; and an output unit outputting the DMX signal converted by the converting unit.

### BRIEF DESCRIPTION OF THE DRAWINGS

FIG. 1 is a block diagram showing a control system according to an embodiment.

FIG. 2 is a block diagram showing an internal configuration of a controller.

FIG. 3 is a block diagram showing an internal configuration of a control signal transmitter.

FIG. 4 is a block diagram showing an internal configuration of a control signal mixer.

FIG. 5 is a block diagram showing an internal configuration of a control signal receiver.

FIG. 6 is a schematic view showing an example signal packet generated in a packet generating unit.

FIG. 7 is a flowchart showing an example of overall operating procedures of the control system.

FIG. 8 is a flowchart showing an example of operating procedures of the control signal mixer.

FIG. 9 is a flowchart showing step S27 in FIG. 8 in more detail.

FIG. 10 is a flowchart showing an example of operating procedures of the control signal transmitter.

FIG. 11 is a flowchart showing an example of operating procedures of the control signal receiver.

### DETAILED DESCRIPTION

Hereinafter an embodiment of the present invention will be described in detail with reference to the drawings.

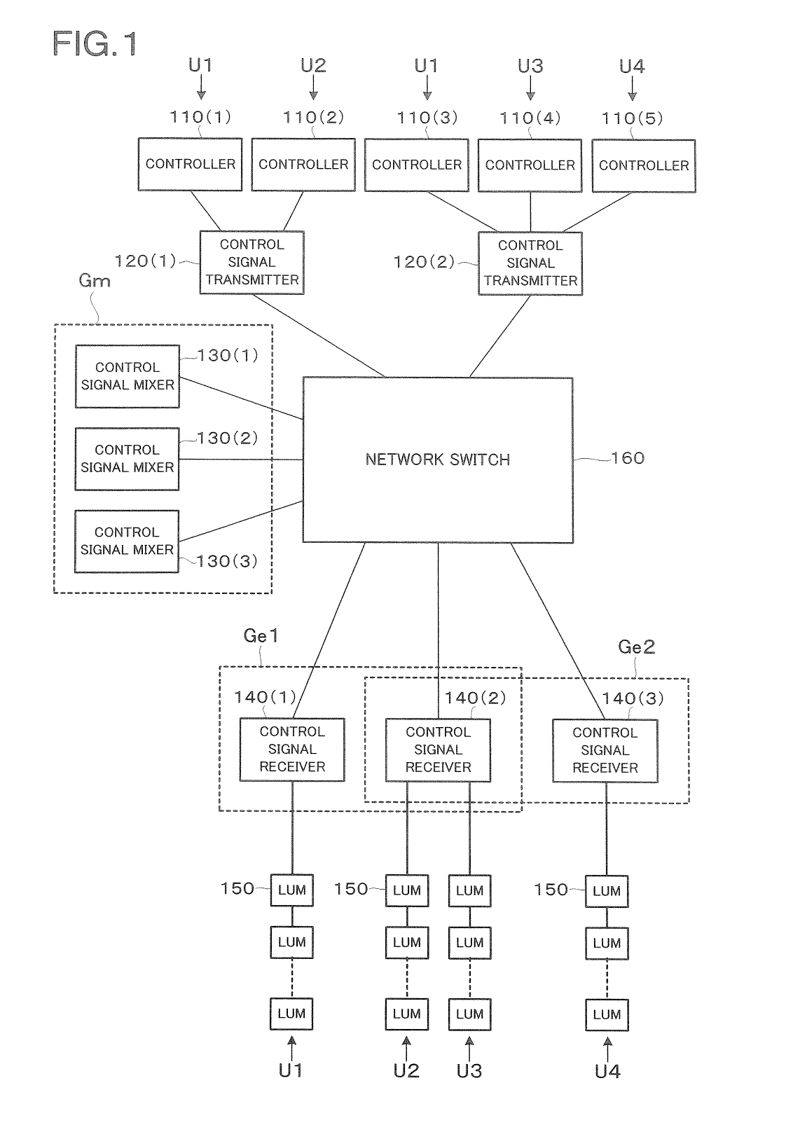

FIG. 1 is a block diagram showing a control system 100 according to an embodiment of the present invention. The control system 100 includes controllers 110 (110 (1) to 110 (5)), control signal transmitters 120 (120 (1), 120 (2)), control signal mixers 130 (130 (1) to 130 (3)), control signal receivers 140 (140 (1) to 140 (3)), lighting systems 150 and a network switch 160.

### (Outline of Control System 100)

The description will be given of the outline of the control system 100.

The lighting system 150 is controlled by a DMX signal from the control signal receiver 140 DMX is a standard that describes a method of digital data transmission between controllers and lighting equipment and accessories. It covers electrical characteristics (based on the EIA/TIA-485 standard), data format, data protocol, and connector type. The DMX signal is a signal standardized to control the lighting system 150 (for example, to control illumination strength, an operation of an illuminating unit and the like). It is possible to control the lighting system 150 by defining a value corresponding to a channel in the DMX signal.

The channel is such an element of the DMX signal that corresponds to a control element (luminance of an illumination, a color of the illumination, a position with respect to one-axis direction (x-axis or y-axis), or the angle in one-axis direction) of the lighting system 150. For instance, the lighting system 150 can be controlled by assigning (each of) 5 to 7 channels to the luminance, the position in the x-axis direction and the tilting angle, respectively, of the lighting system 150. A standard DMX 512 allows controlling the lighting system 150 of 1 to 512 channels by the DMX signals on a single signal line.

The controllers 110 (1) to 110 (5) control the lighting systems 150 corresponding to channel groups U1 to U4, respectively. In response to inputs into the controllers 110, the DMX signals corresponding to the channel groups U1 to U4 are outputted from the control signal receivers 140, so that the lighting systems 150 are controlled.

Here, it is assumed that the controllers 110 (1), 110 (3) control the lighting systems 150 of the same channel croup U1. In other words, the plural controllers 110 are allowed to control the lighting systems 150 of the same channel group.

A channel group Un means a group of plural DMX channels. With the use of the channel group Un, the limitation on the number of channels of the DMX signal can be extended (as previously described, the DMX 512 is limited to 512 channels). For instances, the channel groups U1, U2 each having 512 channels can handle virtually 0 (zero) to 1024 channels. Specifically, it is possible to assign 0001 to 0512 channels and 0513 to 1024 channels to the channel groups U1, U2, respectively.

The control signal mixers 130 are classified into a designated mixer, a non-designated mixer and a backup mixer.

The designated mixer mixes the DMX signals contained in plural signal packets P0 (zero) transmitted from control signal transmitters 120 to generate a mixed signal packet P1 based on the mixed result and transmits the packet. These generation and transmission are executed at certain intervals (for example, 20 msec).

Although the non-designated mixer mixes the DMX signals contained in the signal packets P0, the mixer does not generate nor transmit the mixed signal packet P1. When the designated mixer stops to generate and transmit the mixed signal packet P1 for some reason, then the non-designated mixer generates and transmits the mixed signal packet P1 on behalf of the designated mixer.

The segmentation between the designated mixer and the non-designated mixer is stored in a later-described designated-device storage unit 138. The designated mixer and the non-designated mixer can have the same configuration except the stored content.

The plural control signal mixers 130 are arranged so that the DMX signals are mixed and the mixed signal packet P1 is generated and transmitted without interruption even when any of the plural control signal mixers 130 fails.

In that case, the designated mixer is determined from among the control signal mixers 130 so that the mixed signal packets P1 do not transmitted from the respective control signal mixers 130. Only the designated mixer transmits the mixed signal packet P1. When the designated mixer fails, then the non-designated mixer transmits the mixed signal packet P1 on behalf of the designated mixer. In the event that the designated mixed does not recover immediately, a designated mixer is determined anew from among the non-designated mixers, and the new designated mixer transmits the mixed signal packet P1 thereafter.

The control signal mixers 130 (1) to 130 (3) participate in a single multicast group Gm.

The multicast group means a group receiving a single multicast packet simultaneously. For instance, the multicast packet assigning the multicast group Gm is received by the control signal mixers 130 (1) to 130 (2) respectively at a time. This is because the network switch 160 transmits the multicast packet to each of the devices (control signal mixers 130 (1) to 130 (3)) belonging to the multicast group Gm by copying the multicast packet when relaying the multicast packet.

The control signal receivers 140 participate in one or more multicast group Gen. Here, it is assumed that the control signal receivers 140 (1), 140 (2) participate in a multicast group Ge1 and the control signal receivers 140 (2), 140 (3) participate in a multicast group Ge 2. Specifically, the control signal receiver 140 (2) participates in both the multicast groups Ge1, Ge2. In this manner, the control signal receiver 140 is allowed to participate in the plural multicast group Gen. This is convenient for the control signal receiver 140 to control plural channel groups

### (Internal Configurations of Individual Devices)

Hereinafter, the description will be given in detail of the controller 110, the control signal transmitter 120, the control signal mixer 130, the control signal receiver 140 and the network switch 160.

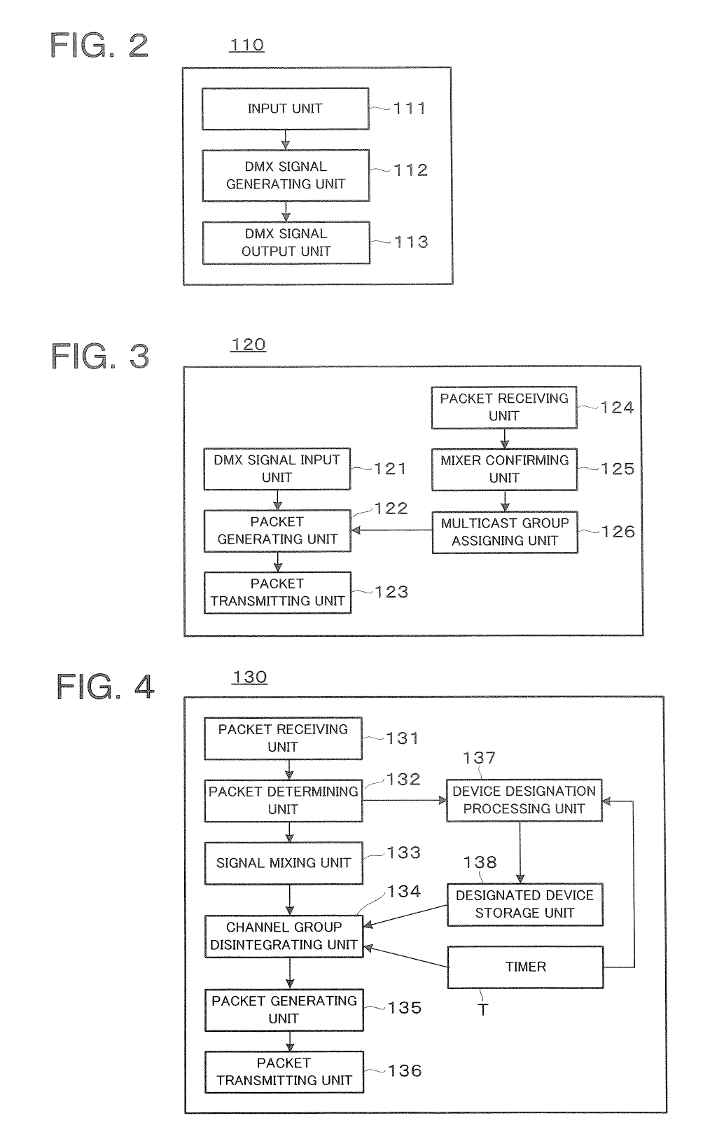

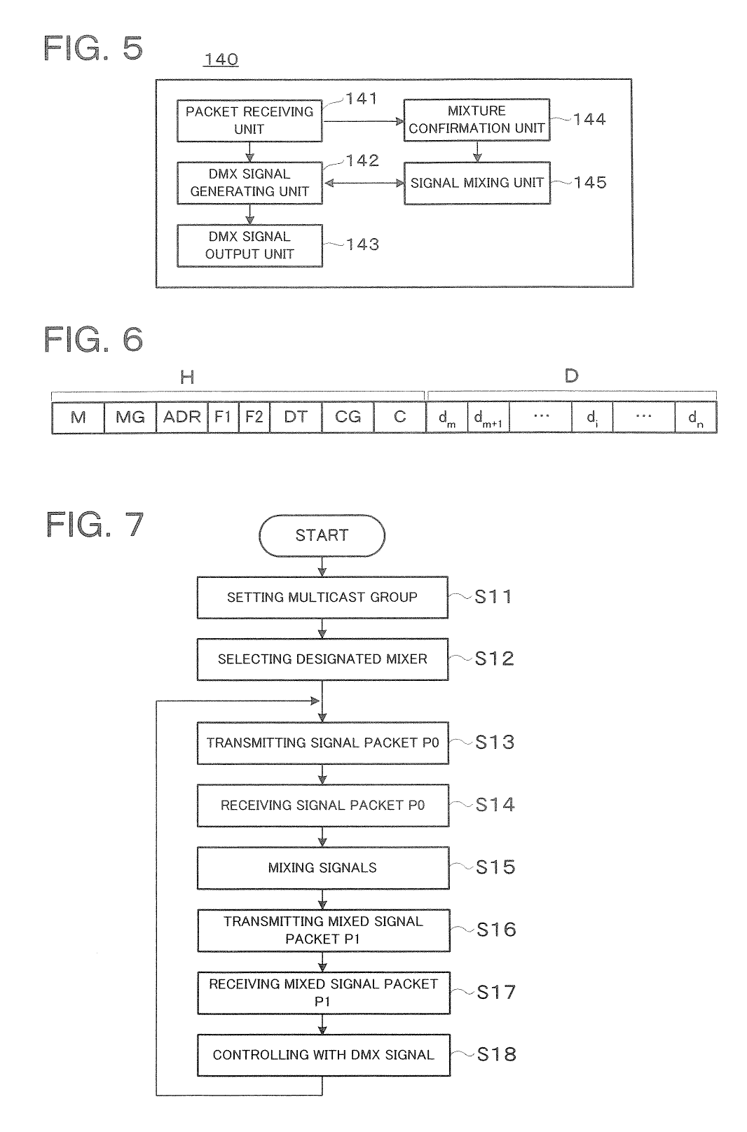

FIGS. 2 to 5 are block diagrams showing internal configurations of the controller 110, the control signal transmitter 120, the control signal mixer 130, the control signal receiver 140 and the network switch 160, respectively.

### A. Detail Description of Controller 110

The controller 110 is a control device to control the lighting system 150. The controller 110 includes an input unit 111, a DMX signal generating unit 112 and a DMX signal output unit 113.

The input unit 111 is an input device operated by a user of the control system 100 to input information to control the lighting system 150. The channel group Un and a value corresponding to a channel are inputted by the input unit 111.

The DMX signal generating unit 112 converts the information inputted by the input unit 111 into the DMX signal. Based on the DMX 512 standard, a single channel group generates 512 bytes (=1 [byte/channel]*512 [channel]) of signals.

The DMX signal output unit 113 outputs the DMX signal generated by the DMX signal generating unit 112.

### B. Detail Description of Control Signal Transmitter 120

The control signal transmitter 120 is a device converting the DMX signals into the signal packets P0 and transmits the packet. The control signal transmitter 120 includes a DMX signal input unit 121, a packet generating unit 122, a packet transmitting unit 123, a packet receiving unit 124, a mixer confirmation unit 125 and a multicast group assignment unit 126.

The DMX signal input unit 121 inputs the DMX signal from the controller 110.

The packet generating unit 122 generates the signal packet P0 based on the DMX signals. Specifically, the conversion from the DMX signals into the IP packets is executed.

FIG. 6 is a schematic view showing an example of the signal packet P0 generated by the packet generating section 122. Note that a packet prescribed by IPv6 or IPv4 can be used for the signal packet P0

The signal packet P0 is classified into a header portion H and a data portion D.

The header portion H includes a multicast identifier M, a multicast group identifier MG, a sender address identifier ADR, flags F1, F2, a data type identifier DT, a channel group identifier CG and a channel identifier C.

The multicast identifier M is information indicating that the signal packet P0 is a multicast packet. Under IPv6, the initial “11111111” of the address corresponds to the multicast identifier M.

The multicast group identifier MG is information identifying the multicast group. Here, as a multicast group, the multicast group Gm is assigned. Specifically, the signal packet P0 transmitted from the control signal transmitter 120 is copied at and retransmitted from the network switch 160 to reach to each of the control signal mixers 130 (1) to 130 (3).

The sender address identifier ADR is information indicating the address of the device transmitting the signal packet P0. Here, the address (IP address or MAC address) of the control signal transmitter 120 is indicated.

The flag F1 indicates whether or not the control signal mixer 130 transmitted the mixed signal packet P1 is the non-designated mixer. When the control signal mixer 130 transmitted the mixed signal packet P1 is the non-designated mixer, the flag F1 becomes ON (the bit of F1 becomes “1”). When the control signal mixer 130 transmitted the mixed signal packet P1 is the designated mixer, the flag F1 does not become ON (the bit of F1 is kept to be “1”).

As will be described later, when the designated mixer fails or the like, then the non-designated mixer transmits the mixed signal packet P1 on behalf of the designated mixer. With flag F1, it is possible to confirm that the mixed signal packet P1 is transmitted from the non-designated mixer.

The flag F2 indicates whether or not the device transmitted the packet is the control signal transmitter 120. When the device transmitted the packet P1 is the control signal transmitter 120, the flag F2 becomes ON (the bit of F2 becomes “1”). When the device transmitted the packet is the control signal mixer 130, the flag F2 does not become ON (the bit of F2 is kept to be “0 (zero)”).

As will be described later, when all of the control signal mixers 130 fail or the like, the control signal transmitter 120 transmits the signal packet P0 directly to the control signal receiver 140. The control signal receiver 140 can confirm that the signal packet P0 is transmitted from the control signal transmitter 120 with the flag F2 (that the DMX signals in the packet are unmixed).

The data type identifier DT is information indicating the type of the data contained in the signal packet P0. As data types, there are two types, namely DMX signal data and internal communication data. The DMX signal data is data for the DMX signal. The internal communication data is data for internal communication between the control signal mixers 130 (for example, to confirm operation). The data type identifier DT of the signal packet P0 is the “DMX signal”.

The channel group identifier CG is information indicating the channel group Un corresponding to the DMX signal contained in the signal packet P0.

The channel identifier C is information indicating the channel range covered by the DMX signals contained in the signal packet P0. For instance, with the combination of the first channel and the last channel, the channel range can be assigned. Further, with the combination of the first channel and information indicating the channels followed thereafter, the channel range can be assigned. In this case, the channels are arranged from the first to the end of the data portion D.

The data portion D has a DMX signal di of i [channel] arranged in the order of the channels.

The packet transmitting unit 123 transmits the packet generated in the packet generating unit 122. At this time, the multicast group assignment unit 126 assigns the multicast group.

The packet receiving unit 124 receives the packet (signal packet P0 or confirmation packet) transmitted from the control signal mixer 130.

The mixer confirmation unit 125 confirms whether or not any of the control signal mixers 130 at least is in operation based on the packet received by the packet receiving unit 124. The mixer confirmation unit 125 stores identification information of the control signal mixers 130 for this confirmation. By comparing this identification information with the packet, whether or not the received packet is the packet transmitted from the control signal mixer 130 is identified. In the case where no packet is received from the control signal mixer 130 for a predetermined time, the mixer confirmation unit 125 recognizes and determines that the operations of all of the control signal mixers 130 are not confirmed. Other than the case, the mixer confirmation unit 125 recognizes and determines that at least any of the control signal mixers 130 is in operation.

The multicast group assignment unit 126 assigns the multicast group based on the confirmation result by the mixer confirmation unit 125. When any operation of the control signal mixers 130 is confirmed by the mixer confirmation unit 125, the multicast group Gm is assigned. When the mixer confirmation unit 125 determines that any operation of the control signal mixers 130 is not confirmed, the multicast group Gen is assigned based on the channel group of the DMX signal. In order to enable this assignment, the multicast group assignment unit 126 has a table showing confirmed or not confirmed operations of the control signal mixers 130, the channel groups and the multicast groups in a corresponding manner.

When the multicast group assignment unit 126 assigns the multicast group Gm, the signal packet P0 transmitted from the packet transmitting unit 123 is transmitted to the control signal mixer 130. The signal packet P0 is converted into the mixed signal packet by the control signal mixer 130 to be received by the control signal receiver 140.

Meanwhile, when the multicast group assignment unit 126 assigns the multicast group Gen, the signal packet P0 transmitted from the packet transmitting unit 123 is received by the control signal receiver 140 without going through the control signal mixer 130. Specifically, the control signal receiver 140 receives the signal packet P0 experiencing no mixing process. Note that when the multicast group Gen is assigned, the flag F2 of the signal packet P0 is turned ON in the packet generating unit 122 to indicate that the data of the packet is unmixed.

As will be described below, in this case, the signals are mixed on the control signal receiver 140 side. The control signal receiver 140 can determine whether or not the signals are required to be mixed by the flag F2 of the signal packet P0.

### C. Detail Description of Control Signal Mixer 130

The control signal mixer 130 includes a packet receiving unit 131, a packet determining unit 132, a signal mixing unit 133, a channel group disintegrating unit 134, a packet generating unit 135, a packet transmitting unit 136, a device designation processing unit 137, a designated device storage unit 138, and a timer T.

The packet receiving unit 131 receives the signal packet P0 from the control signal transmitter 120 or a packet P3 between the control signal mixers 130

The packet determining unit 132 determines the received packet to be either the signal packet P0 from the control signal transmitter 120 or the packet P3 transmitted between the control signal mixers 130. For the determination, the data type identifier DT contained in the packet is used.

The signal mixing unit 133 mixes the DMX signals contained in the plural signal packets P0 transmitted from the control signal transmitter 120 to reduce the data amount of the DMX signals, to finally reduce the number of the signal packets P0. This mixture means that the DMX signals having both the same channel group Un and the channel ch are mixed into a single DMX signal.

As to the two DMX signals, the signals are mixed in a manner that two values V1_{n,ch}, V2_{n,ch} of the same channel group Un and the channel ch are mixed into a single value V3_{n,ch}. For instance, the value V3_{n,ch} is generated as described below.

$$\begin{matrix}V {3}_{n , ch} = V {1}_{n , ch} ( if V {1}_{n , ch} \cdot V {2}_{n , ch} ) \\ = V {2}_{n , ch} ( if V {2}_{n , ch} > V {1}_{n , ch} )\end{matrix}$$

Specifically, V3_{n,ch} is defined as the larger one of V1_{n,ch} and V2_{n,ch}. In this case, it is possible to determine the DMX signal having the larger value V3_{n,ch} to be the mixed DMX signal by comparing the DMX signal of the received signal packet P0 and the mixed DMX signal.

Other than the above, a variety of mixing processes are conceivable. For instance, the value V_{n,ch} contained in the signal packet P0 arrived at the end of a predetermined time is determined as the mixed value. In this case, the mixed DMX signal is replaced so that the DMX signal of the received signal packet P0 comes to the mixed DMX signal.

The signal mixing unit 133 includes a buffer memory at a previous stage or a subsequent stage of the mixing process, as required. The buffer memory at the previous stage holds the DMX signal before the mixing process. The buffer memory at the subsequent stage holds the DMX signal after the mixing process.

The channel group disintegrating unit 134 disintegrates the mixed DMX signal into the channel groups Un. Note that it is also possible that the signal mixing unit 133 mixes the DMX signals for each channel group Un.

The packet generating unit 135 generates the mixed signal packet P1 based on corresponding data generated in the channel group disintegrating unit 134. In this generation, the packet generating unit 135 determines the multicast group Gen based on the channel group identifier CG (together with the channel identifier C as the case may be) contained in the signal packet P0. The packet generating unit 135 includes a group table for this determination. In the group table, for example, the channel group Un (together with the channel identifier C as the case may be) as well as the multicast group Gen are shown in a corresponding manner. Here, it is acceptable that the DMX signals of the same channel group Un and the channel ch correspond to the plural multicast groups Ge1, Ge2.

The mixed signal packet P1 can be expressed by FIG. 6 as in the signal packet P0. Specifically, the mixed signal packet P1 is classified into the header portion H and the data portion D. The header portion H includes the multicast identifier M, the multicast group identifier MG, the sender address identifier ADR, flags F1, F2, the data type identifier DT, the channel group identifier CG and the channel identifier C.

Here, the multicast group identifier MG of the mixed signal packet P1 indicates the multicast group Gen. Specifically the mixed signal packet P1 transmitted from the control signal mixer 130 is copied and retransmitted from the network switch 160 to reach to the control signal receivers 140 belonging to the multicast groups Ge1, Ge2 simultaneously.

In the data portion D, the DMX signals mixed by the signal mixing unit 133 and disintegrated by the channel group disintegrating unit 134 are arranged.

Except the above, the mixed signal packet P1 has the same configuration as of the signal packet P0, and thereby the detail description is omitted here.

The packet transmitting unit 136 transmits the packet generated by the packet generating unit 135

The device designation processing unit 137 executes a process to determine the designated mixer from among the plural control signal mixers 130.

The designated device storage unit 138 stores the information identifying the designated mixer.

### D. Detail Description of Control Signal Receiver 140

The control signal receiver 140 includes a packet receiving unit 141, a DMX signal generating unit 142, a DMX signal output unit 143, a mixture confirmation unit 144 and a signal mixing unit 145.

The packet receiving unit 141 receives the mixed signal packet P1 from the control signal mixer 130.

The DMX signal generating unit 142 generates the DMX signal based on the mixed signal packet P1 received by the packet receiving unit 141. Specifically, the conversion from the IP packets into the DMX signals is executed.

The DMX signal output unit 143 outputs the DMX signal generated by the DMX signal generating unit 142 to the lighting system 150.

The mixture confirmation unit 144 confirms the DMX data contained in the packet received by the packet receiving unit 141 to be mixed or unmixed. The confirmation can be performed based on ON/OFF of the flag F2 of the packet.

When the mixture confirmation unit 144 determines that the DMX signal is unmixed, the signal mixing unit 145 mixes it with the DMX signal generated by the DMX signal generating unit 142. Specifically, the control signal receiver 140 includes a part of the functions of the control signal mixer 130 as well. Even when all of the control signal mixers 130 fail, the mixing of signals and the multicasting by the packet are allowed.

### E. Detail Description of Network Switch 160

The network switch 160 is a device to relay the packet between the control signal transmitters 120, control signal mixers 130 and control signal receivers 140, and, for example, a router or a hub. The network switch 160 copies the multicast packet in accordance with the destinations and distributes them to the multicast groups Gm, Gen. The network switch 160 has a table for this distribution. In the table, the multicast groups and identification information identifying the devices belonging to the groups are shown in a corresponding manner.

### (Operation of Control System 100)

### A. Overall Operation of the Control System 100

FIG. 7 is a flowchart showing an example of overall operating procedures of the control system 100

### (1) Setting Multicast Group (step S11)

As previously described, there exist two types of multicast groups Gm, Gen in the control system 100.

### 1) Setting Multicast Group Gm

It is possible to statically determine the multicast group Gm in advance and store the group Gm in the control signal mixer 130 and the control signal transmitter 120. Also, it is possible to distribute the information on the multicast group Gm in the form of SLP (Service Location Protocol), DHCP (Dynamic Host Configuration Protocol), SDP (Session Description Protocol) or the like. 2) Setting multicast group Gen

It is preferable that the multicast group Gen is determined so that the load of the control signal receiver 140 is reduced. For instance, the multicast group Ge can be determined as described below.

When the signal line and channel group Un correspond one to one as in DMX 512, it is possible to assign the multicast group Gen to each channel group Un.

It is possible to divide the channel group Un into plural subclasses, for example, four subclasses being 1 to 138, 139 to 256, 257 to 384, and 385 to 512, and assign the multicast groups Ge1 to Ge4 to the subclasses, respectively.

Further, the respective channels are expressed by being mapped to bit lines as in Bloom Filter, and the assignment to the multicast group Gen can be determined based thereon.

As described above, based on the channel group Un (together with channel ch as the case may be), the multicast group Gen is determined. In the present embodiment, as described before, the channel groups U1 to U3 and U4 correspond to the multicast group Ge1 and Ge2, respectively.

### (2) Selecting Designated Mixer (step S12)

When there are plural control signal mixers 130, any one of the control signal mixers 130 is selected as the designated mixer and the other control signal mixer 130 becomes the non-designated mixer.

For selecting the designated mixer, a variety of methods are conceivable as described below.

It is possible for a user to determine and set the designated mixer before booting the control signal mixers 130. Here, it is possible to notify the control signal mixers 130 of the designated mixer using a multicasting to the multicast group Gm.

As in a method of selecting a designated router under OSPF (RFC2328), the designated mixer may be determined autonomously by and among the control signal mixers 130

The control signal mixers 130 (1) to 130 (3) determine which control signal mixer 130 is the designated mixer. For instance, the control signal mixer 130 (1) is selected as a designated mixer.

### (3) Transmitting Signal Packet P0 from Control Signal Transmitter 120 (Step S13).

The signal packet P0 is transmitted from the control signal transmitter 120. This transmission is executed by the procedures 1) and 2) below.

### 1) Outputting DMX Signal from Controller 110 to Control Signal Transmitter 120

The DMX signals of the channel groups U1 U2 are outputted from the controllers 110 (1), 110 (2), respectively, to the control signal transmitter 120 (1). Also, the DMX signals of the channel groups U1, U3, U4 are outputted from the controllers 110 (3) to 110 (5), respectively, to the control signal transmitter 120 (2). The DMX signals are outputted from the controllers 110 to the control signal transmitters 120, synchronously or asynchronously. (2) Transmitting signal packet P0 from control signal transmitter 120

The signal packet P0 is transmitted from the control signal transmitter 120. This transmission is performed at regular intervals. Each of both the control signal transmitters 120 (1), 120 (2) transmits the signal packet P0 to the multicast group Gm.

In response to the inputs from the controllers 110 (1), 110 (2), the control signal transmitter 120 (1) generates and transmits the signal packet P0 containing the DMX signals of the channel groups U1, U2. In response to the inputs from the controllers 110 (3) to 110 (5), the control signal transmitter 120 (2) generates and transmits the signal packet P0 containing the DMX signals of the channel groups U1, U3, U4.

### (4) Receiving Signal Packet P0 by Control Signal Transmitter 130 (Step S14)

The signal packet P0 from the control signal transmitter 120 is transmitted to the multicast group Gm via the network switch 160. Each of the control signal mixers 130 (1) to 130 (3) receive the packet toward the multicast group Gm.

Note that the control signal mixers 130 are assumed to execute a participating process to the multicast group Gm before receiving the signal packets P0. Specifically, the control signal mixers 130 request the network switch 160 for participations in the multicast group Gm and the network switch 160 accepts the request. The participation in the multicast group Gm means that they are registered in the distribution table of the network switch 160.

### (5) Mixing Signals (Step S15)

The control signal mixer 130 mixes the DMX signals contained in the signal packets P0 received during a predetermined time. Note that this mixing is executed regardless of the fact that the control signal mixer 130 is the designated mixer or not.

### (6) Transmitting Mixed Signal Packet P1 from the Control Signal Mixer 130 (Step S16)

The mixed signal packet P1 is generated by and transmitted from the control signal mixer 130. The mixed signal packet P1 is transmitted to the multicast groups Ge1, Ge2. The generation and transmission is executed by the control signal mixer 130 (1) being the designated mixer. However, when it is unable to confirm the operation of the designated mixer, then the control signal mixer 130 (2) or 130 (3) generates and transmits the mixed signal packet P1

### (7) Receiving Mixed Signal Packet P1 by Control Signal Receiver 140 (Step S17)

The control signal receiver 140 receives the mixed signal packet P1 addressed to the multicast group needed. In this example, the control signal receiver 140 (1) receives only the packet addressed to the multicast group Ge1. The control signal receiver 140 (2) receives the packets addressed to the multicast groups Ge1, Ge2. The control signal receiver 140 (3) receives only the packet addressed to the multicast group Ge2.

### (8) Controlling Lighting System 150 with DMX Signal (Step S18).

The mixed signal packet P1 received by the control signal receiver 140 is converted into the DMX signal, and the lighting system 150 is controlled therewith.

As described above, the lighting system 150 is controlled by the operation of the controller 110 B. Detail description of control signal mixer 130

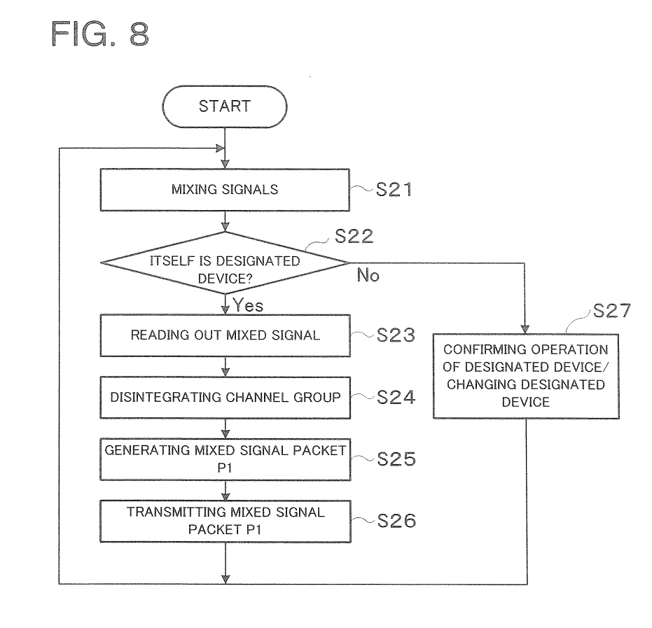

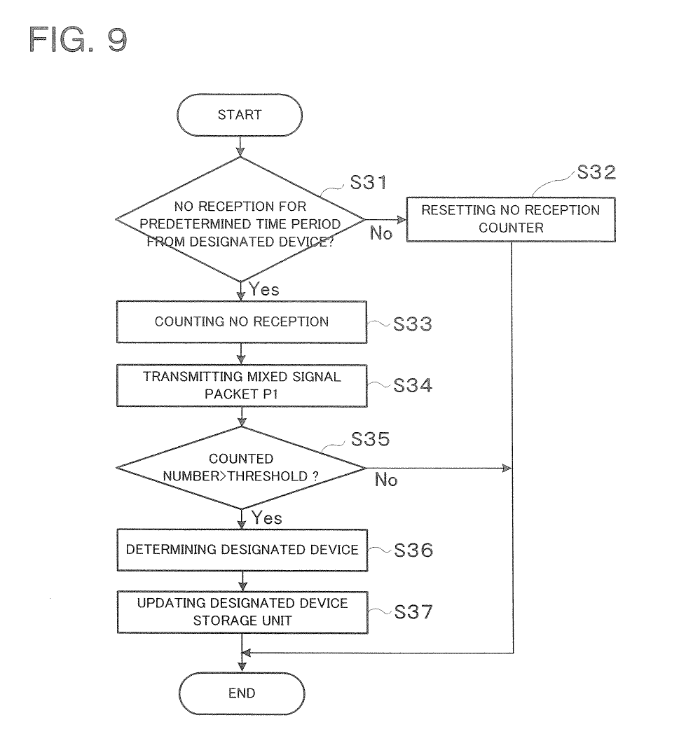

The description will be given of the operation of the control signal mixer 130 in detail. FIG. 8 is a flowchart showing an example of operating procedures of the control signal mixer 130 FIG. 9 is a flowchart showing step S27 in FIG. 8 in more detail.

### (1) Mixing Signals (Step S21)

This step S21 is the same as of the above-described step S15. The signal mixing unit 133 of the control signal mixer 130 mixes the DMX signals contained in the signal packets P0 received during a predetermined time. This mixing is executed regardless of the fact that the control signal mixer 130 is the designated mixer or not. Specifically, the control signal mixers 130 (1) to 130 (3) mix the DMX signals contained in the received signal packets P0 for each channel and channel group, independently.

### (2) Determining Designated Mixer (Step S22)

The channel group disintegrating unit 134 of the control signal mixer 130 determines whether or not the mixer itself is the designated mixer. This can be determined by confirming the stored content of the designated device storage unit 138. The channel group disintegrating unit 134 of the control signal mixer 130 (1) determines that the mixer itself is the designated mixer. The channel group disintegrating units 134 of the control signal mixer 130 (2), 130 (3) determine, respectively, that the mixer itself is the non-designated mixer.

### (3) Process for Designated Mixer (Steps S23 to S26)

The control signal mixer 130 determined to be the designated mixer generates and transmits the mixed signal packet P1. Each of the other control signal mixers 130 (non-designated mixers) only mixes the packets, and transmits the signal packet only in the event that the designated mixer is determined to be failed.

1) The channel group disintegrating unit 134 of the control signal mixer 130 (1) determines that the mixer itself is the designated mixer and starts reading out the mixing result from the signal mixing unit 133 at certain time intervals.

2) The channel group disintegrating unit 134 of the control signal mixer 130 (1) disintegrates the mixing result into the respective channel groups. In the present embodiment, the mixed DMX signal is disintegrated into DMX signals of four types corresponding to four channel groups U1 to U4.

3) The packet generating unit 135 of the control signal mixer 130 (1) generates the mixed signal packet(s) P1 corresponding to the channel group U1 to U4 and the multicast groups Ge1, Ge2. In the present embodiments for the multicast group Ge1, three mixed signal packets P1 corresponding to the channel groups U1 to U3, respectively, are generated. Further, for the multicast group Ge 2, a single mixed signal packet P1 corresponding to the channel group U4 is generated.

4) The packet transmitting unit 136 of the control signal mixer 130 (1) transmits the generated mixed signal packets P1 to the multicast groups Ge1, Ge, respectively.

### (4) Process for Non-Designated Mixer (Step S27, Steps S31 to S36)

The non-designated mixer confirms whether or not the designated mixer operates. In addition, the designated mixer is changed as required (step S27). The confirmation and change are executable based on classification described below (steps S31 to S36).

1) The channel group disintegrating unit 134 of the non-designated mixer confirms whether or not the control signal mixer 130 being the designated mixer operates. For instance, it is possible to find the failure of the designated mixer by transmitting the packet (confirmation packet) at regular intervals from the designated mixer to the non-designated mixer. Specifically, when the non-designated mixer does not receive the packet for a predetermined time, the designated mixer is determined to be failed (stepS31). In addition, in response to received or not-received from the designated mixer, a counter is increased or reset (steps S32, S33).

Each of the channel group disintegrating units 134 of the control signal mixers 130 (2), 130 (3) determines that the mixer itself is not the designated mixer and waits to receive the packet from the control signal mixer 130 (1) to confirm the operation of the control signal mixer 130 (1).

Each of the channel group disintegrating units 134 of the control signal mixers 130 (1), 130 (2) determines that the control signal mixer 130 (1) is in operation when the confirmation packet is received, and resets the non-received counter to 0 (zero). In the meantime, no confirmation packet is received for a predetermined time, the counter is increased by one.

As a confirmation packet, as described below, various packets can be employed.

As a confirmation packet, the use of an explicit keep-alive packet is conceivable.

It is also possible to use the signal packet concurrently as a confirmation packet. Specifically, not only the control signal receiver 140 but also the non-designated mixer is configured to be able to receive the signal packet transmitted by the designated mixer. For this purpose, it is conceivable that the non-designated mixer also participates in the multicast group Gm in which the control signal receiver 140 participates.

Note that the packet transmitted from the designated mixer may be divided by such a method as Forward Error Correction (FEC) and the number thereof, eventually the frequency in the operation confirmation of the designated mixer may be increased. In this case, the DMX signals belonging to the same channel group Un are divided and arranged in plural packets.

2) When no operation is confirmed in the designated mixer, the non-designated mixer transmits the mixed signal packet P1 on behalf of the designated mixer (step S34).

The channel group disintegrating units 134 of the control signal mixers 130 (2), 130 (3) read out the current mixing result from the signal mixing units 133 and disintegrate them for each channel group.

The packet generating unit 135 of the control signal mixer 130 (2) generates and transmits the mixed signal packets P1 corresponding to the multicast groups Ge1, Ge2, Gm. Specifically, the mixed signal packet P1 is transmitted also to the multicast group Gm. Further, the flag F1 of the mixed signal packet P1 is turned ON to indicate that the transmission is made on behalf of the designated mixer. Consequently, the other non-designated mixer (control signal mixer 130 (3)) is allowed to confirm that the mixed signal packet P1 is transmitted from the non-designated mixer (control signal mixer 130 (2)).

Note that the packet transmitting unit 136 of the control signal mixer 130 (2) is capable of ensuring a short and random delay time before transmitting the packet. The delay time is to prevent these mixed signal packets P1 from being transmitted at the same time by varying their timings transmitted from the control signal mixers 130 (2), 130 (3).

The control signal mixer 130 (3) confirms that the mixed signal packet P1 is transmitted from the control signal mixer 130 (2) and does not transmit the mixed signal packet P1. It is prevented that the mixed signal packets P1 are transmitted from both the control signal mixers 130 (2), 130 (3), so that the control signal receiver 140 is prevented from receiving the mixed signal packet P1 doubly. When the control signal mixer 130 (3) has transmitted the mixed signal packet P1 in first, then the control signal mixers 130 (2) does not transmit the mixed signal packet P1.

3) When the designated mixer fails, the designated mixer selection is performed again. When the not-received number of the times of the counter exceeds a predetermined value (threshold value), the designated mixer is determined to be failed, and the designated mixer is determined again. In accordance with this determination result, the stored content of the designated device storage unit 138 is updated (steps S35 to S37).

### C. Detail Description of Control Signal Transmitter 120

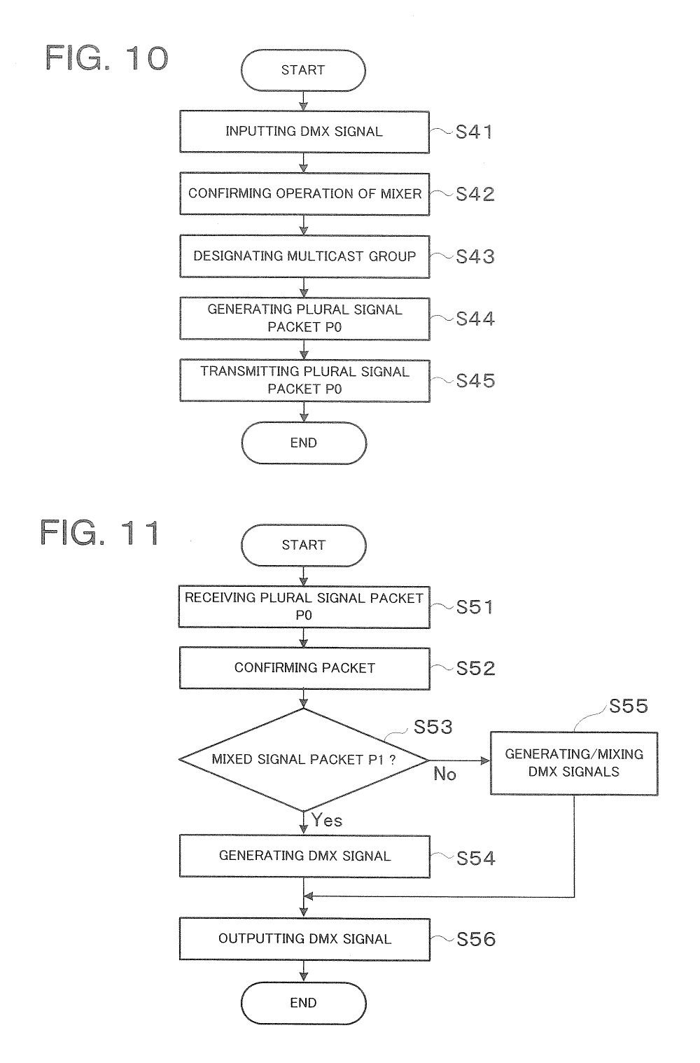

The description will be given of the operation of the control signal transmitter 120 in detail. FIG. 10 is a flowchart showing an example of operating procedures of the control signal transmitter 120. Here, the case where the control signal transmitter 120 performs multicasting on behalf of the control signal mixer 130 when all of the control signal mixers 130 are failed is being taken into consideration

### (1) Inputting DMX Signal (Step S41)

The DMX signal is inputted into the DMX signal input unit 121 of the control signal transmitter 120.

### (2) Confirming Operation of Control Signal Mixer 130 (Step S42)

Whether or not the control signal mixer 130 operates is confirmed by the mixer confirmation unit 125 of the control signal transmitter 120. For this purpose, methods as described below are conceivable as examples.

A packet instructing to transmit the keep-alive packet to the multicast group Gm is transmitted from the control signal transmitter 120. Whether or not the control signal mixer 130 is in operation can be confirmed by the fact that the keep-alive packet is returned or is not returned from the control signal mixer 130 in compliance with the instruction.

Whether or not the keep-alive packets transmitted from the control signal mixer 130 at regular intervals are received by the control signal transmitter 120 is confirmed.

Whether or not the mixed signal packet P1 transmitted from the control signal mixer 130 is received by the control signal transmitter 120 is confirmed.

### (3) Assigning Multicast Group (Step S43)

The multicast group assignment unit 126 assigns the multicast group. At this time, in accordance with the confirmation result confirming whether or not the control signal mixer 130 is in operation, the multicast group is switched. Specifically, when the operation of the control signal mixer 130 is confirmed, the multicast group Gm is assigned, and when not, the multicast group Ge is assigned.

### (3) Generating and Transmitting Signal Packet P0 (Steps S44, S45)

Based on the assignment of the multicast group in step S43, the packet generating unit 122 and the packet transmitting unit 123 generates and transmits the signal packet P0, respectively.

When the operation of the control signal mixer 130 is confirmed, the signal packet P0 is transmitted to the control signal mixer 130. On the other hand, when the operation of the control signal mixer 130 is not confirmed, the signal packet P0 is transmitted to the control signal receiver 140 directly. As a result, even when all of the control signal mixers 130 are failed, the control signal receiver 140 can receive the signal packet.

Note that when the packet is transmitted to the control signal receiver 140 directly, the flag F2 of the signal packet P0 is turned ON to indicate that the packet is transmitted directly from the control signal transmitter 120. This flag F2 indicates that the packet does not go through the control signal mixer 130 and thereby is unmixed.

### D. Detail Description of Control Signal Receiver 140

The description will be given of the operation of the control signal mixer 140 in detail. FIG. 11 is a flowchart showing an example of operating procedures of the control signal receiver 140.

### (1) Receiving and Confirming Packet (Steps S51, S52)

The packet receiving unit 141 of the control signal receiver 140 receives the packet. The mixture confirmation unit 144 confirms the received packet. Specifically, the received packet is determined to be the signal packet P0 or the mixed signal packet P1. This confirmation can be made by confirming whether or not the flag F2 of the received packet is ON.

### (2) Generating DMX Signal and Mixing Signals (Steps S53 to S55)

In accordance with the confirmation result of the packet, the DMX signal is generated and mixed by the DMX signal generating unit 142 and the signal mixing unit 145, respectively. Specifically, when the received packet is the mixed signal packet P1 the DMX signal is generated from the packet. Meanwhile, when the received packet is the signal packet P0, the DMX signal is generated from the packet and is mixed with the DMX signals generated from the plural packets. This is because that the signal packet P0 is transmitted directly from the control signal transmitter 120 without mixing signals.

Here, the case where the control signal receiver 140 does not carry the mixing function will be taken into consideration. This means that the control signal receiver 140 does not include the mixture confirmation unit 144 and the signal mixing unit 145. In this case, the DMX signal generating unit 142 of the control signal receiver 140 generates the DMX signal from the received packet and outputs as it is. In other words, even when the received packet is the signal packet P0, the parcket is converted into the DMX signal without mixing signals. Thus, even when a part or all of the control signal receivers 140 does/do not include the mixing function, the control system 100 can operate.

### (3) Outputting DMX Signal (Step S56)

The generated DMX signal is outputted from the DMX signal output unitl43 of the control signal receiverl40, so that the lighting system 150 is controlled by the DMX signal.

### (Modification Example 1)

The transmission of the packet from the control signal transmitter 120 to the control signal mixer 130 may be performed by unicasting instead of multicasting. In this case, the control signal transmitter 120 unicasts the signal packet to the respective control signal mixers 130 instead of multicasting the signal packet to the multicast group Gm.

### (Modification Example 2)

The transmission of the packet from the control signal mixer 130 to the control signal receiver 140 may be performed by broadcasting instead of multicasting. Since the signals in the packet are mixed, the number of packets is expected to be reduced even when it is broadcasted. Specifically, even when the number of the control signal transmitters 120 increases, the number of the packets that the control signal receiver 140 has to receive does not increase linearly together with the number of the control signal transmitters 120. Notwithstanding the above, the multicasting is more preferable in that the number of packets to be received can be reduced further.

### (Other Modifications)

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents

What is claimed is:

1. A signal mixer, comprising:
a receiving unit receiving plural multicast packets each containing a DMX signal;
a mixing unit mixing the DMX signals contained in the plural multicast packets received by said receiving unit;
a generating unit generating a packet containing the DMX signal mixed by said mixing unit; and
a transmitting unit transmitting the packet generated by said generating unit.

2. The signal mixer as set forth in claim 1,
wherein the plural multicast packets received by said receiving unit include first and second DMX signals controlling devices belonging to first and second groups, respectively, and
said generating unit generates first and second packets including the first and second DMX signals, respectively.

3. The signal mixer as set forth in claim 2,
wherein the first and second packets generated by said generating unit are multicast packets corresponding to the first and second groups, respectively.

4. The signal mixer as set forth in claim 2, further comprising a dividing unit dividing the DMX signal mixed by said mixing unit into the first and second DMX signals.

5. The signal mixer as set forth in claim 2,
wherein said mixing unit mixes the first and second DMX signals, respectively.

6. The signal mixer as set forth in claim 1,
wherein said generating unit generates plural signal packets each containing at least a part of the DMX signal mixed by said mixing unit.

7. The signal mixer as set forth in claim 1, further comprising:
a storage unit storing identification information identifying a designated device; and
an identification unit identifying said signal mixer to be the designated device or not based on the identification information stored in said storage unit,
wherein when said identification unit identifies said signal mixer to be the designated device, said generating unit generates the signal packet.

8. The signal mixer as set forth in claim 7, further comprising a detection unit detecting no packet reception from the designated device for a predetermined time period when said identification unit identifies said signal mixer not to be the designated device,
wherein when said detection unit detects the no packet reception, said generating unit generates the signal packet.

9. The signal mixer as set forth in claim 7, further comprising a determination unit determining a designated device from among said other signal mixers when said detection unit detects no packet reception a predetermined times.

10. A signal transmitter, comprising:
an input unit inputting a DMX signal;
a generating unit generating a multicast packet containing the DMX signal inputted by said input unit; and
a transmitting unit transmitting the multicast packet generated by said generating unit.

11. The signal transmitter as set forth in claim 10, further comprising:
a storage unit storing identification information identifying a designated device;
a detection unit detecting no packet reception from the designated device for a predetermined time period; and
an assignment unit assigning a multicast group based on the detection result by said detection unit,
wherein said generating unit generates the multicast packet addressed to the multicast group assigned by said assignment unit.

12. The signal transmitter as set forth in claim 11,
wherein the DMX signal inputted by said input unit contains a signal component controlling a device belonging to a first group; and
wherein said assignment unit assigns the multicast group corresponding to the first group when said detection unit detects no packet reception from the designated device.

13. The signal transmitter as set forth in claim 11,
wherein said generating unit generates a multicast packet containing a predetermined flag when said detection unit detects no packet reception from the designated device.

14. A signal receiver, comprising:
a receiving unit receiving a multicast packet containing a DMX signal;
a converting unit converting the multicast packet received by said receiving unit into the DMX signal; and
an output unit outputting the DMX signal converted by said converting unit.

15. The signal receiver as set forth in claim 14, further comprising:
a detection unit detecting whether or not the DMX signal contained in the multicast packet is already mixed based on whether or not the multicast packet received by said receiving unit contains a predetermined flag; and
a mixing unit mixing plural DMX signals converted by said converting unit when the DMX signal contained in the multicast packet is determined to be not mixed by said detection unit,
Wherein said output unit outputs the DMX signal mixed by said mixing unit.
